(19) United States
(12) Patent Application Publication
(10) Pub. No.: US 2026/0308737 A1
(43) Pub. Date: Oct. 8, 2026

(54) LOW IRON LOSS Fe-BASED AMORPHOUS ALLOY HAVING HIGH SATURATION MAGNETIZATION VALUE

(71) Applicant: CHANG SUNG CO., Incheon (KR)

(72) Inventors: Soon Cheol JEONG, Incheon (KR); Sung Soo KIM, Seoul (KR); Min Seok KANG, Incheon (KR); Tae Kyung LEE, Incheon (KR)

(21) Appl. No.: 19/210,411

(22) Filed: May 16, 2025

(30) Foreign Application Priority Data
Mar. 25, 2025 (KR) 10-2025-0038230

(51) Int. Cl. C22C 45/02; B22F 1/05; B22F 1/065; H01F 1/153

(52) U.S. Cl. CPC C22C 45/02; B22F 1/05; B22F 1/065; H01F 1/15308; B22F 2301/35; B22F 2304/10; B22F 2999/00; C22C 2200/02; C22C 2202/02

(57) ABSTRACT

An embodiment relates to an amorphous alloy capable of simultaneously achieving a high saturation magnetization value and low core loss properties. According to the embodiment, the sphericity of produced powder is improved, and the saturation magnetization value and magnetic flux density are high, and the core loss is low, so that the alloy is usable as a core material for a power conversion device, an inductor, or a transformer.

### CROSS-REFERENCE TO RELATED APPLICATIONS

This application claims priority from Korean Patent Application No. 10-2025-0038230, filed on Mar. 25, 2025, in the Korean Intellectual Property Office, which is incorporated herein by reference in its entirety.

### BACKGROUND

The disclosure relates to an amorphous alloy, and more specifically, to an amorphous alloy capable of simultaneously achieving a high saturation magnetization value and low core loss properties.

Iron-based amorphous alloys are new energy-saving, environmentally friendly, soft magnetic materials that have no grain and grain boundary defects and low magnetic anisotropy, and thus exhibit excellent properties such as high permeability, high saturation magnetization strength, high resistivity, low coercivity, and low loss.

In iron-based amorphous composites, the magnetic properties do not greatly depend on the direction due to the grain-free structure, which may further reduce the magnetic anisotropy and magnetostriction effects of the alloy. As a result, they have high saturation magnetization strength and high permeability, and are widely used in various fields such as power, electronics, information transmission, and conversion.

However, in the previously developed Fe—Si—B—C amorphous alloys, it was difficult to obtain an Fe-based alloy with high saturation flux density of 1.5 Tesla or higher and low core loss.

In addition, even if an Fe-based alloy of 1.5 Tesla or higher is made, there is a problem in that it is difficult to obtain low core loss properties because the coercivity increases and eddy current phenomenon occurs if a crystalline phase is included in the alloy.

Meanwhile, since high core loss has a negative effect on inductor efficiency, it is essential to secure amorphous properties when producing Fe-based alloys.

In order to solve this problem, attempts have been continuously made to adjust the composition by adding various elements, but they have not been able to satisfy low core loss properties while having magnetic flux density of 1.5 Tesla or higher.

### RELATED ART DOCUMENT

### Patent Document

(Patent Document 0001) Chinese Patent Publication CN 108251765 A

### SUMMARY

The disclosure is a method for solving the problems of the above-mentioned related art, and is to provide an Fe—Si—B—P—C amorphous alloy having an optimized composition ratio that may satisfy low core loss while exhibiting low core loss and high saturation flux density, specifically, high saturation flux density of 1.5 Tesla or higher.

The aspect of the disclosure is not limited to that mentioned above, and other aspects not mentioned will be clearly understood by those skilled in the art from the description below.

An example of the disclosure provides an amorphous alloy having a high saturation magnetization value.

An amorphous alloy according to an example of the disclosure is represented by a chemical composition of Fe_{100-(a+b+c+d)}SiₐB_{b}P_{c}C_{d}, and the atomic percentages of each element satisfy 3.5 at %≤a≤6.5 at %, 7.5 at %≤b≤11 at %, 0.3 at %≤c≤1.8 at %, 2.8 at %≤d≤6.2 at %.

In an example of the disclosure, the b may be 7.8 at %≤b≤10.8 at %.

In an example of the disclosure, the c may be 0.5 at %≤c≤1.5 at %.

In an example of the disclosure, the d may be 3.0 at %≤d≤6.0 at %.

In an example of the disclosure, the b, c, d may satisfy 0.05≤c/(b+c+d)≤0.1.

In an example of the disclosure, the b, c, d may satisfy 0.2≤d/(b+c+d)≤0.4.

In an example of the disclosure, the amorphous alloy may have a saturation magnetization value of 175 emu/g or higher.

In an example of the disclosure, the amorphous alloy may have a saturation magnetic flux density value of 1.5 T or higher.

In an example of the disclosure, the b, c, d may satisfy 14.5≤b+c+d≤15.

Another example of the disclosure may provide magnetic powder including the amorphous alloy.

An amorphous alloy according to an example of the disclosure has the following effects.

### (1) Improvement of Powder Sphericity

The addition of an appropriate amount of phosphorus (P) improved the sphericity, thereby increasing the packing density of the powder. This enabled a high molding density during a core producing process, thereby realizing high magnetic flux density and low core loss at the same time.

### (2) Improvement of Saturation Magnetization and Magnetic Flux Density

The saturation magnetization value (Ms) was improved to 175 emu/g or higher, and the magnetic flux density (Bs) was also increased to 1.5 T or higher. This may contribute to miniaturization of the core by allowing higher magnetic flux to flow in the core of the same volume.

### (3) Core Loss Reduction

The powder made of the alloy of the disclosure achieved core loss reduction of 10 to 15% compared to the existing amorphous magnetic powder, which may greatly contribute to lowering heat generation and reducing energy loss under high-frequency operating conditions.

### (4) Improvement of Direct Current Superposition Properties

The direct current superposition properties were improved by about 5 to 7% compared to the existing amorphous magnetic powder, which means improvement of DC bias properties in application devices such as inductors. It is advantageous for designing small inductors because the magnetization change due to DC current is small.

In addition, since an amorphous alloy according to an example of the disclosure has the above-mentioned excellent effects, the alloy is usable as a core material of a power conversion device such as a high-frequency switching power supply (SMPS), an inductor, or a transformer.

The effects of the disclosure are not limited to the effects described above, and should be understood to include all effects that are inferable from the configuration of the disclosure described in the detailed description or claims of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a graph showing sphericity by particle size of example 1, comparative example 1, and comparative example 2;

FIG. 2 is a graph showing Bs (magnetic flux density) of example 1, comparative example 1, and comparative example 2;

FIG. 3 is a graph showing Core Loss of example 1, comparative example 1, and comparative example 2; and

FIG. 4 is a graph showing the results of the DC bias properties of example 1, comparative example 1, and comparative example 2.

### DETAILED DESCRIPTION

Hereinafter, the disclosure will be described with reference to the accompanying drawings. However, the disclosure may be implemented in various different forms and therefore is not limited to the embodiments described herein. In addition, in order to clearly describe the disclosure in the drawings, parts that are not related to the description are omitted, and similar parts are given similar drawing reference numerals throughout the specification.

In the entire specification, when a part is said to be “connected (linked, contacted, coupled)” to another part, this includes not only the case where it is “directly connected” but also the case where it is “indirectly connected” with another member in between. In addition, when a part is said to “include” a certain component, this does not exclude other components unless specifically stated to the contrary, but rather means that other components may be additionally provided.

The terms used in this specification are used only to describe specific embodiments and are not intended to limit the disclosure. The singular expression includes the plural expression unless the context clearly indicates otherwise. In this specification, the terms “include” or “have” are intended to specify the presence of a feature, number, step, operation, component, part, or combination thereof described in the specification, but should be understood as not excluding in advance the possibility of the presence or addition of one or higher other features, numbers, steps, operations, components, parts, or combinations thereof.

Hereinafter, embodiments of the disclosure will be described in detail with reference to the accompanying drawings.

The disclosure is to provide an Fe-based amorphous alloy having excellent DC bias properties while having high saturation magnetic flux density and low core loss.

An amorphous alloy according to an example of the disclosure is an Fe—Si—B—P—C amorphous alloy having a high saturation magnetization value, characterized by being represented by a chemical composition of Fe_{100-(a+b+c+d)}SiₐB_{b}P_{c}C_{d}.

In the amorphous alloy according to an example of the disclosure, the content of Fe may be in a range of 74.5 at % or higher and 85.9 at % or less, more preferably 75.2 at % or higher and 85.2 at % or less, and most preferably 78 at % or higher and 85.2 at % or less. The high Fe content as described above may improve the saturation magnetic flux density properties of the amorphous alloy.

Meanwhile, in an example of the disclosure, the combined addition of Si and B, which are metalloid elements, and P and C, which are nonmetals, improves the corrosion resistance, heat resistance, and mechanical properties of the Fe-based amorphous alloy, and in particular, plays an important role in promoting amorphous formation by hindering crystal growth.

Specifically, Si (silicon) plays a role in minimizing the internal stress of powder while maintaining the amorphous properties, and at the same time improves the magnetic properties to enhance the magnetic flux density and saturation magnetization value. In the amorphous alloy composition of the disclosure, Si may be included in an amount of 3.5 at %≤a≤6.5 at %, or higher preferably, 4 at %≤a≤6 at %.

In addition, B (boron) improves the amorphous formation ability, thereby contributing to reducing core loss by allowing more free movement of magnetic domains. B may be 7.5 at %≤b≤11 at %, or higher preferably 7.8 at %≤b≤10.8 at % in the above composition, and by adjusting the content of boron within the above-mentioned range, the amorphous structure may be stabilized, thereby increasing the magnetic flux density (Bs) and the saturation magnetization value (Ms).

P (phosphorus) is added to secure thermal stability and improve the sphericity of the amorphous powder, and the improvement of sphericity increases the filling ratio of the powder and improves the molding density during core production, thereby reducing the core loss. P may be 0.3 at %≤c≤1.8 at %, or higher preferably 0.5≤c≤1.5 at % in the above composition, and by adjusting the content of phosphorus within the above-mentioned range, high molding density is enabled, thereby simultaneously realizing the high magnetic flux density and low core loss.

C (carbon) plays a role in suppressing crystallization in high-content Fe-based alloys, and C can be controlled to 2.8 at %≤d≤6.2 at %, or better, 3.0 at %≤d≤6.0 at % in the above composition to suppress crystallization at relatively high Fe contents and secure amorphous properties, thereby improving the saturation magnetization value.

In addition, in an example of the disclosure, the b, c, and d may satisfy 0.05≤c/(b+c+d)≤0.1 as a first condition, 0.2≤d/(b+c+d)≤0.4 as a second condition, 14.5≤b+c+d≤15 as a third condition, or satisfy two conditions out of the above three conditions at the same time, or most preferably satisfy three conditions at the same time.

An amorphous alloy satisfying the above conditions may more easily achieve the purpose of the disclosure, which is to have a high saturation magnetization value while reducing core loss. However, the disclosure is not necessarily limited to these conditions.

An amorphous alloy according to an example of the disclosure may have a saturation magnetization value of 175 emu/g or higher.

In addition, the amorphous alloy may have a saturation magnetic flux density value of 1.5 T or higher.

Another example of the disclosure may provide magnetic powder including the amorphous alloy.

The alloy and the magnetic powder including the alloy of the disclosure have the following effects.

### (1) Improvement of Powder Sphericity

The addition of an appropriate amount of phosphorus (P) improved the sphericity, thereby increasing the packing density of the powder. This enabled a high molding density during a core producing process, thereby realizing high magnetic flux density and low core loss at the same time.

### (2) Improvement of Saturation Magnetization and Magnetic Flux Density

The saturation magnetization value (Ms) was improved to 175 emu/g or higher, and the magnetic flux density (Bs) was also increased to 1.5 T or higher. This may contribute to miniaturization of the core by allowing higher magnetic flux to flow in the core of the same volume.

### (3) Core Loss Reduction

The powder made of the alloy of the disclosure achieved core loss reduction of 10 to 15% compared to the existing amorphous magnetic powder, which may greatly contribute to lowering heat generation and reducing energy loss under high-frequency operating conditions.

### (4) Improvement of Direct Current Superposition Properties

The direct current superposition properties were improved by about 5 to 7% compared to the existing amorphous magnetic powder, which means improvement of DC bias properties in application devices such as inductors. It is advantageous for designing small inductors because the magnetization change due to DC current is small.

The alloy and magnetic powder according to an example of the disclosure may be used as a core material for power conversion devices such as high-frequency switching power supplies (SMPS), in particular, and has the characteristic of low core loss that may reduce heat generation and improve efficiency during high-frequency operation.

In addition, since miniaturization and high efficiency may be achieved based on high magnetic flux density and low core loss, application thereof to inductors is possible.

In addition, since low loss may be maintained even under high-frequency operating conditions, application thereof as a core for small transformers is possible.

Hereinafter, the disclosure will be described in more detail through production examples, comparative examples, and experimental examples. However, the disclosure is not limited to the following production examples and experimental examples.

### Production Example

An Fe—Si—B—P—C amorphous alloy was produced according to examples and comparative examples.

Table 1 below shows the atomic % content of each metal in the produced alloy.

TABLE 1

| | | | | | | | P/ | C/ |
|---|---|---|---|---|---|---|---|---|
| Division | Fe | Si | B | P | C | B + P + C | (B + P+ C) | (B + P + C) |
| Example 1 | 80.25 | 5.00 | 7.97 | 0.95 | 5.83 | 14.75 | 0.064 | 0.395 |
| Example 2 | 80.25 | 5.00 | 8.38 | 0.77 | 5.60 | 14.75 | 0.052 | 0.380 |
| Example 3 | 80.25 | 5.00 | 9.29 | 1.08 | 4.38 | 14.75 | 0.073 | 0.297 |
| Example 4 | 80.25 | 5.00 | 9.77 | 1.21 | 3.77 | 14.75 | 0.082 | 0.256 |
| Example 5 | 80.25 | 5.00 | 10.15 | 0.88 | 3.72 | 14.75 | 0.060 | 0.252 |
| Example 6 | 80.25 | 5.00 | 10.62 | 1.02 | 3.11 | 14.75 | 0.069 | 0.211 |
| Comparative | 78.88 | 5.93 | 13.21 | 0.00 | 1.98 | 15.19 | 0.000 | 0.130 |
| example 1 | | | | | | | | |
| Comparative | 77.19 | 5.93 | 7.18 | 2.50 | 7.20 | 16.88 | 0.148 | 0.427 |
| example 2 | | | | | | | | |
| Comparative | 80.25 | 5.00 | 8.28 | 0.23 | 6.24 | 14.75 | 0.016 | 0.423 |
| example 3 | | | | | | | | |
| Comparative | 80.25 | 5.00 | 10.03 | 2.01 | 2.71 | 14.75 | 0.136 | 0.184 |
| example 4 | | | | | | | | |
| Comparative | 80.25 | 5.00 | 13.50 | 0.61 | 0.64 | 14.75 | 0.041 | 0.043 |
| example 5 | | | | | | | | |
| Comparative | 80.25 | 5.00 | 11.25 | 3.50 | 0.00 | 14.75 | 0.237 | 0.000 |
| example 6 | | | | | | | | |
| Comparative | 80.25 | 5.00 | 7.16 | 0.00 | 7.59 | 14.75 | 0.000 | 0.515 |
| example 7 | | | | | | | | |

### Experimental Example

The experimental properties of the produced metal magnetic powder according to an example and comparative example were analyzed.

The saturation magnetization value (Ms) was measured using equipment of LakeShore, and the saturation magnetic flux density (Bs) was calculated considering the density.

The sphericity was measured as an average value using equipment of MICROTRAC, and it was divided into each particle size (10~50 μm) and presented in a graph.

The core loss (magnetic core loss, mW/cc) represents the energy loss that occurs when an AC field is applied, and it was measured under the conditions of 1 MHz frequency and 20 mT magnetic field strength.

The sample used for the measurement was a toroidal core, and the core was formed with a pressurized molding density of 1.65 ton/cm², and the magnetic properties were measured by including 25 wt % of Carbonyl Iron Powder (CIP) and 3 wt % of a binder in the amorphous alloy powder.

DC properties were expressed by winding copper wire around a core formed by the above method, applying current of up to 40 A, and measuring the decrease % of L value (permeability) using an LCR meter.

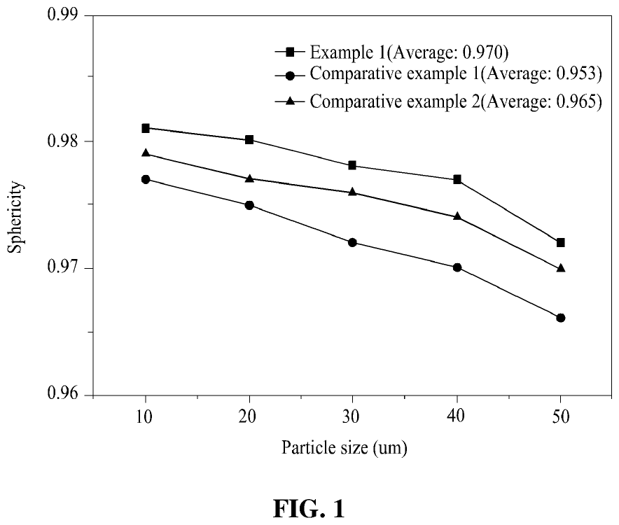

FIG. 1 is a graph showing sphericity by particle size of example 1, comparative example 1, and comparative example 2.

Referring to FIG. 1, it is possible to confirm that the magnetic powder according to an example of the disclosure has high sphericity. It is possible to see that, especially in example 1, because the phosphorus content is controlled to an appropriate composition range, a high molding density may be implemented, unlike comparative example 1 with a low phosphorus content and comparative example 2 with a high phosphorus content.

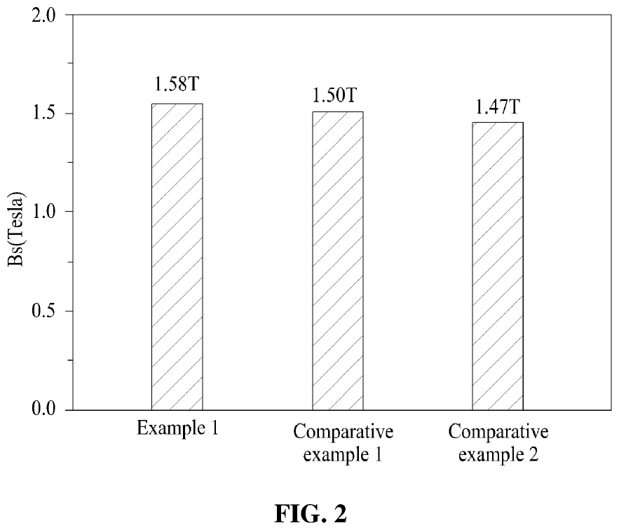

FIG. 2 is a graph showing Bs (magnetic flux density) of example 1, comparative example 1, and comparative example 2. Likewise, it is possible to confirm that comparative examples 1 and 2 have lower magnetic flux densities than an example of the disclosure, where the contents of Si, B, P, and C are controlled under certain conditions and ranges.

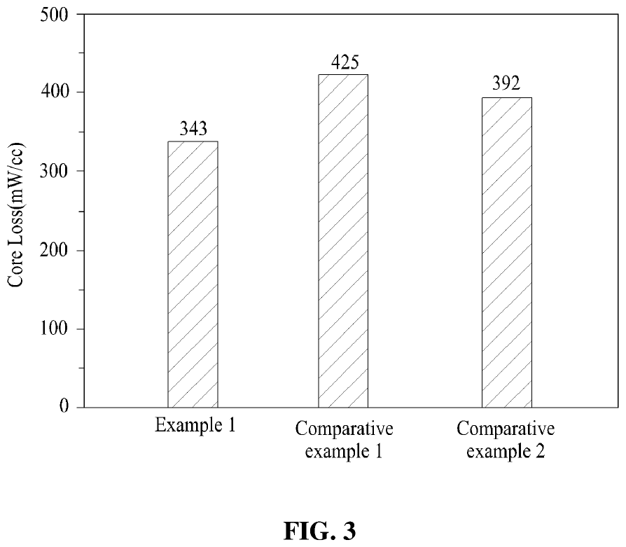

FIG. 3 is a graph showing core loss of example 1, comparative example 1, and comparative example 2. Similarly, it is possible to confirm that comparative examples 1 and 2 have higher core loss than an example of the disclosure, where the contents of Si, B, P, and C are controlled under certain conditions and ranges.

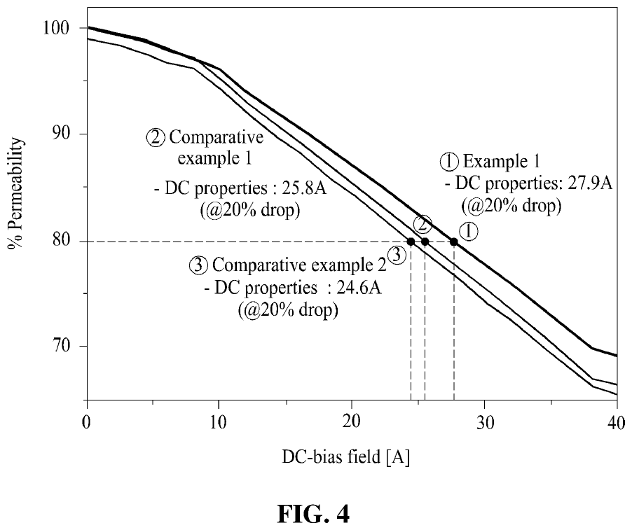

FIG. 4 is a graph showing the results of the DC bias properties of example 1, comparative example 1, and comparative example 2. Likewise, it is possible to confirm that an example of the disclosure, where the contents of Si, B, P, and C are controlled under certain conditions and ranges, has improved DC bias properties compared to a comparative example.

Table 2 below shows the sphericity, amorphous properties, saturation magnetization (Ms), magnetic flux density (Bs), core loss, and direct current superposition properties of powder containing an alloy according to an example and comparative example of the disclosure.

Referring to Table 2, it is possible to confirm that the amorphous alloy powder according to an example of the disclosure maintains amorphous properties, and has superior magnetic properties and lower core loss compared to a comparative example group.

TABLE 2

| | | | | | core | direct |
|---|---|---|---|---|---|---|
| | | amorphous | Ms | Bs | loss | current |
| Division | sphericity | properties | (g/emu) | (T) | (mW/cc) | superposition |
| Example 1 | 0.970 | amorphous | 176.8 | 1.58 | 343 | 7% ↑ |
| Example 2 | 0.969 | amorphous | 175.8 | 1.58 | 353 | 5% ↑ |
| Example 3 | 0.972 | amorphous | 177.9 | 1.60 | 361 | 7% ↑ |
| Example 4 | 0.975 | amorphous | 178.1 | 1.60 | 368 | 7% ↑ |
| Example 5 | 0.969 | amorphous | 176.3 | 1.58 | 348 | 6% ↑ |
| Example 6 | 0.971 | amorphous | 176.5 | 1.59 | 425 | 6% ↑ |
| Comparative | 0.953 | amorphous | 166.5 | 1.50 | 425 | — |
| example 1 | | | | | | |
| Comparative | 0.965 | amorphous | 161.5 | 1.47 | 392 | — |
| example 2 | | | | | | |
| Comparative | 0.955 | amorphous/ | 178.5 | 1.60 | 548 | — |
| example 3 | | crystalline | | | | |
| Comparative | 0.957 | amorphous/ | 177.6 | 1.59 | 518 | — |
| example 4 | | crystalline | | | | |
| Comparative | 0.961 | amorphous/ | 177.5 | 1.59 | 495 | — |
| example 5 | | crystalline | | | | |
| Comparative | 0.968 | amorphous/ | 176.8 | 1.59 | 477 | — |
| example 6 | | crystalline | | | | |
| Comparative | 0.970 | amorphous/ | 178.2 | 1.60 | 523 | — |
| example 7 | | crystalline | | | | |

The description of the disclosure is for illustrative purposes, and those skilled in the art will understand that it can be easily modified into other specific forms without changing the technical idea or essential features of the disclosure. Therefore, the embodiments described above should be understood as being exemplary in all respects and not limiting. For example, each component described as a single type may be implemented in a distributed manner, and likewise, components described as distributed may be implemented in a combined form.

The scope of the disclosure is indicated by the following claims, and all changes or modifications derived from the meaning and scope of the claims and their equivalent concepts should be interpreted as being included in the scope of the disclosure.

1. An amorphous alloy of Fe—Si—B—P—C, comprising:
the amorphous alloy having a high saturation magnetization value, wherein the amorphous alloy is represented by a chemical composition of Fe_{100-(a+b+c+d)}SiₐB_{b}P_{c}C_{d}, and atomic percentages of each element satisfy 3.5 at %≤a≤6.5 at %, 7.5 at %≤b≤11 at %, 0.3 at %≤c≤1.8 at %, and 2.8 at %≤d≤6.2 at %.

2. The amorphous alloy of claim 1, wherein an atomic percentage of the b satisfies 7.8 at %≤b≤10.8 at %.

3. The amorphous alloy of claim 1, wherein an atomic percentage of the c satisfies 0.5 at %≤c≤1.5 at %.

4. The amorphous alloy of claim 1, wherein an atomic percentage of the d satisfies 3.0 at %≤d≤6.0 at %.

5. The amorphous alloy of claim 1, wherein the b, c, and d satisfy 0.05≤c/(b+c+d)≤0.1.

6. The amorphous alloy of claim 1, wherein the b, c, and d satisfy 0.2≤d/(b+c+d)≤0.4.

7. The amorphous alloy of claim 1, wherein the amorphous alloy has a saturation magnetization value of 175 emu/g or higher.

8. The amorphous alloy of claim 1, wherein the amorphous alloy has a saturation magnetic flux density value of 1.5 T or higher.

9. The amorphous alloy of claim 1, wherein the b, c, and d satisfy 14.5≤b+c+d≤15.

10. Magnetic powder comprising the amorphous alloy of claim 1.
